(19) United States
(12) Patent Application Publication
(10) Pub. No.: US 2022/0330628 A1
(43) Pub. Date: Oct. 20, 2022

(54) PLEATED PROTECTIVE CLOTHING

(71) Applicant: Jong Eun Kim, Seoul (KR)

(72) Inventor: Jong Eun Kim, Seoul (KR)

(21) Appl. No.: 17/619,746

(22) PCT Filed: Jun. 18, 2020
(86) PCT No.: PCT/KR2020/007916

§ 371 Date: Dec. 16, 2021

(30) Foreign Application Priority Data
Jun. 21, 2019 (KR) 10-2019-0074028
Jun. 21, 2019 (KR) 10-2019-0074030

(51) Int. Cl. A41D 13/02; A41D 13/002; A41D 13/005

(52) U.S. Cl. CPC A41D 13/02; A41D 13/0025; A41D 13/0058; A41D 2200/20

(57) ABSTRACT

Provided is a pleated protective clothing worn by a worker in order to protect a body of a worker from an external environment and maintain a clean work environment, the pleated protective clothing including: a hood portion configured to cover a head of a worker; an upper body portion connected with the hood portion and configured to surround an upper body of the worker; and a hood pleated portion formed in a portion connecting the hood portion and the upper body portion and having elasticity.

### TECHNICAL FIELD

The present invention relates to pleated protective clothing, and more particularly, to pleated protective clothing which enables a worker to freely move, improves mobility of a worker, and provides a comfortable fit.

### BACKGROUND ART

In general, protective clothing is clothes worn by workers to protect the bodies of workers in various industrial environments or to maintain a clean working environment, and is worn in the case where there is a need to protect workers from pollutants, fine dust, and chemicals that are harmful to the human body and generated during work in the industrial field, or in the case where it is necessary to block particles or static electricity generated from the body or clothing of the worker so that the workplace is maintained in a clean room or semi-clean room condition in environment conditions where the workpiece may he contaminated due to static electricity or foreign. substances, such as particles, that exist in the workplace, such as in a semiconductor manufacturing process, and defective products may be generated.

When the above protective clothing is used in an industrial field, products certified according to the Ministry of Employment and Labor Notice No. 2014-1.6 Protective Equipment Safety Certification Notice must be used, and the standard for the type and format is classified into types 1 to 6 by performance of the protective clothing according to the performance standards of protective clothing for chemical substances (refer to Table 1) of Table 8-2 of the Notice of the Ministry of Employment and Labor.

TABLE 1

| Type | | Type classification criteria |
|---|---|---|
| 1-type | 1a-type | Gas-tight protective clothing with an air |
| | | supply for breathing independent of the |
| | | atmosphere, such as an open air respirator, |
| | | inside the protective clothing |
| | 1a-type | 1a-type protective clothing for emergency |
| | (for | |
| | emergency) | |
| | 1b-type | Gas-tight protective clothing with an air |
| | | supply for breathing, such as an open air |
| | | respirator, on the outside of the protective |
| | | clothing |
| | 1b-type | 1b-type protective clothing for emergency |
| | (for | |
| | emergency) | |
| | 1c-type | Gas-tight protective clothing supplied with |
| | | positive pressure air for breathing, such as |
| | | an air line |

| | |
|---|---|
| 2-type | Gas non-blocking protective clothing |
| | supplied with positive pressure air for |
| | breathing, such as an air line |
| 3-type | Protective clothing with liquid blocking |
| | performance If hoods, gloves, boots, visors, |
| | and respirator are connected, they must |
| | also have liquid blocking performance. |
| 4-type | Protective clothing with spray blocking |
| | performance If hoods, gloves, boots, visors, |
| | and respirator are connected, they must |
| | also have spray blocking performance. |
| 5-type | Protective clothing with blocking |
| | performance against aerosols, such as dust |
| 6-type | Protective clothing with mist blocking |
| | performance |

Further, in the form of protective clothing to have the above performance, the protective clothing is largely divided into integrated protective clothing, such as full body protective clothing, and detachable protective clothing consisting of a top and a bottom, and hood-integrated protective clothing with a hood, which is a type of integrated protective clothing, has the advantage of minimizing the opening and closing parts to the outside and isolating the outside and the worker as much as possible, so the hood-integrated protective clothing is often used in industrial sites.

However, the existing hood-integrated protective clothing is made of a material with little elasticity, so it is difficult to pliably bend the neck or waist of the worker during work, and damage, such as tearing or stretching, may occur when an excessive motion is performed.

In addition, in the invention in the related art, since the flexibility of the protective clothing is improved by increasing the width of the protective clothing or changing the material of the fabric, additional costs are incurred as the amount of fabric required for manufacturing increases or the material is replaced with a fabric with improved flexibility, and in the case of replacing the fabric material of protective clothing with a special flexible fabric, there is a problem in that the manufactured fabric cannot be resistant to heat, moisture, or all kinds of chemicals or radiation, so that there is a need for a method that can improve the flexibility of protective clothing while using various types of fabrics.

The criteria for the flexibility of the protective clothing may be confirmed through the active motion test, for example, first, a worker climbs up a ladder. Second, while standing, a worker twists his/her back 90 degrees and raises both arms to shoulder height. Third, in a standing state, a worker raises both arms upward as far as possible. Fourth, in a standing state, a worker bends one knee and brings the other knee into contact with the ground, bends the waist so that the hand on the side where the knee touches the ground touches the floor, and lowers the head so that the face is facing the ground. Fifth, in a standing state, a worker brings both knees to be in contact with the ground and bends his/her waist so that both hands touch the around. Sixth, in a standing state, a worker bends both knees to 90 degrees and extends both arms forward. Seventh, in a standing state, a worker bends one knee, brings the other knee to be in contact with the ground, touches the hand on the side where the knee touches the ground touches the thigh of the same side, and raises the other hand over the head. Through this, it is possible to test the activity behavior of the protective clothing. In this case, if the protective clothing is torn or stretched according to each motion, it can be said that the flexibility of the protective clothing is low, and it is possible to measure the flexibility of protective clothing by checking the degree of comfort and discomfort experienced by workers wearing protective clothing while acting motion.

Further, the protective clothing is designed to prevent external contaminants from entering the inside, and outside air does not flow inside, and heat generated from the body is not released to the outside, so it is difficult to control the body temperature of workers wearing the protective clothing.

Consequently, a pleasant environment is not provided to the worker, and thus, as the worker develops a skin irritation or stress frequently occurs, research has been conducted to solve the problem.

In addition, the protective clothing is generally made for single use and is intended to be disposed after a single use, but because of the cost burden in small institutions and laboratories, the protective clothing is often recycled, and since it is not easy to clean the protective clothing after use, there has been a risk of infection by other workers wearing the placed protective clothing.

### DISCLOSURE

### Technical Problem

The present invention is conceived to solve the foregoing problems, and an object of the present invention is to provide pleated protective clothing which increases flexibility of a part of the protective clothing that corresponds to the neck or waist, which is a body part that a worker wearing the protective clothing often bends, in order for the protective clothing to have maximum flexibility even if the protective clothing is not made of flexible fabric or is not loose, in order to solve the problem that the worker wearing the protective clothing cannot smoothly move due to the low flexibility of the protective clothing.

Further, another object of the present invention provides protective clothing provided with a blower fan, in which a blower fan is provided in protective clothing to allow the outside air to be introduced into the protective clothing while filtering fine dust or chemicals in a working environment in which fine dust or chemicals are generated, so that it is possible to prevent a body temperature of the worker wearing the protective clothing and a temperature inside the protective clothing from increasing, and which maintains the worker's physical homeostasis while keeping the oxygen concentration and humidity inside the protective clothing at an appropriate level, and in which the blower fan is easily detachable from the protective clothing to reduce weight of the protective clothing and facilitate an activity of a worker when the blower fan is not used, the blower fan having failure is easily replaced, and the blower fan is stably fixed to prevent a direction of an inflow of the outside air from being changed.

In addition, another object of the present invention provides protective clothing which is mounted with a contamination identifying part for determining the degree of contamination of the protective clothing to prevent a worker wearing the protective clothing or other workers from checking the degree of contamination of the protective clothing and replacing or reusing the protective clothing.

### Technical Solution

An exemplary embodiment of the technical spirit of the present invention for achieving the foregoing object provides a pleated protective clothing worn by a worker in order to protect a body of a worker from an external environment and maintain a clean work environment, the pleated protective clothing including: a hood portion configured to cover a head of a worker; an upper body portion connected with the hood portion and configured to surround an upper body of the worker; and a hood pleated portion formed in a portion connecting the hood portion and the upper body portion and having elasticity.

Further, the hood pleated portion may be formed of at least one neck vertical string, and a neck pleated bending portion in which a plurality of pleats is vertically formed by the neck vertical string.

In addition, the pleated protective clothing may further include: a lower body portion connected with the upper body portion and configured to surround a lower body of the worker; and a waist pleated portion formed in a portion connecting the upper body portion and the lower body portion and having elasticity.

Further, the waist pleated portion may be formed of at least one waist vertical string, and a waist pleated bending portion in which a plurality of pleats is vertically formed by the waist vertical string.

In addition, the pleated protective clothing may further include a lateral pleated portion formed in the portion connecting the upper body portion and the lower body portion and having elasticity.

Further, the lateral pleated portion may be formed of at least one lateral vertical string, and a lateral pleated bending portion in which a plurality of pleats is vertically formed by the lateral vertical string.

In addition, the lower body portion may include a knee pleated portion which is formed at a position corresponding to a knee and has elasticity.

Further, the knee pleated portion may be formed of at least one knee vertical string, and a knee pleated bending portion in which a plurality of pleats is vertically formed by the knee vertical string.

In addition, the pleated protective clothing may further include a circulation part provided in at least one of the hood portion, the upper body portion, and the lower body portion.

Further, the circulation part may include: a pocket formed in the protective clothing; and a blower fan operated in the state of being inserted into the pocket.

In addition, the circulation part may be made of an elastic material, and include a fixing band which is formed inside the pocket and fixes the blower fan.

Further, the pleated protective clothing may further include a contamination identifying part which is provided in at least one of the hood portion, the upper body portion, and the lower body portion, and determines the degree of contamination of the protective clothing.

In addition, the contamination identifying part may be provided to be detachably attached to the protective clothing.

### Advantageous Effects

The pleated protective clothing according to the present invention includes the pleats formed in the neck or the waist, so that there are excellent effects in that when a worker performs a motion in the form of stretching a corresponding part, the worker is capable of performing the motion comfortably and easily, even if the protective clothing is made of fabrics made of inflexible materials, the probability of damage to the protective clothing due to excessive movement of workers is reduced, when the worker returns to an original state from the motion in which the corresponding part is stretched, the pleats with elastic restoring force returns to its original length, so the protective clothing does not become loose, and it is possible to reduce the manufacturing cost added due to increase in the size of the protective clothing and increase in the width of the protective clothing or due to use of a fabric with high flexibility in order to increase activity of the worker.

Further, the pleated protective clothing according to the present invention has the excellent effects in that the blower fan is provided in the protective clothing to filter fine dust or chemicals while allowing outside air to flow into the protective clothing in a work environment where fine dust or chemicals are generated, and this prevents an increase in the body temperature of the worker wearing the protective clothing and the temperature inside the protective clothing, the oxygen concentration and humidity inside the protective clothing are kept at an appropriate level, and the worker's physical homeostasis is maintained, since it is possible to detach the blower fan from the protective clothing, when the blower fan is not used, the protective clothing and the blower fan can be separated to reduce the weight of the protective clothing and facilitate the worker's activity, in case the blower fan breaks down, no separate repair work is required and anyone can easily replace the blower fan, the blower fan is stably fixed in the pocket by the blower fan fixing part, so the blower fan does not deviate from the fixed position even if the worker performs various body movements, and the direction of outside air inflow is maintained, when the opening and closing part of the pocket is formed with a zipper or Velcro, it is easy to open and close the pocket and the blower fan does not separate from the pocket, the pocket may be used as a pocket when the blower fan and protective clothing are separated, and when multiple pockets are installed on the upper hip or side, the installation location of the blower fan may be selected arbitrarily by the worker, so it is possible to install and use the blower fan in a position that does not interfere with work as much as possible.

Furthermore, the pleated protective clothing according to the present invention has the excellent effects in that it is possible to easily identify the degree of contamination of the protective clothing and prevent infection due to recycling.

The effects of the present invention are not limited to the foregoing effects, and other non-mentioned effects will be clearly understood by those skilled in the art from the description below.

### DESCRIPTION OF DRAWINGS

FIG. 1 is a diagram illustrating a shape of a front part of pleated protective clothing according to an exemplary embodiment of the present invention.

FIG. 2 is a diagram illustrating a shape of a rear part of the pleated protective clothing according to the exemplary embodiment of the present invention.

FIG. 3 is a cross-sectional view in the state where a neck pleated portion is bent in the pleated protective clothing according to the exemplary embodiment of the present invention.

FIG. 4 is a cross-sectional view in the state where the neck pleated portion is stretched in the pleated protective clothing according to the exemplary embodiment of the present invention.

FIG. 5 is a cross-sectional view in the state where a waist pleated portion is bent in the pleated protective clothing according to the exemplary embodiment of the present invention.

FIG. 6 is a cross-sectional view in the state where the waist pleated portion is stretched in the pleated protective clothing according to the exemplary embodiment of the present invention.

FIG. 7 is a cross-sectional view in the state where a lateral pleated portion and a knee pleated portion are bent in the pleated protective clothing according to the exemplary embodiment of the present invention.

FIG. 8 is a cross-sectional view in the state where the lateral pleated portion is bent and stretched in the pleated protective clothing according to the exemplary embodiment of the present invention.

FIG. 9 is a cross-sectional view in the state where the knee pleated portion is bent in the pleated protective clothing according to the exemplary embodiment of the present invention.

FIG. 10 is a cross-sectional view in the state where the knee pleated portion is stretched in the pleated protective clothing according to the exemplary embodiment of the present invention.

FIG. 11 is a perspective view illustrating a circulation part in the pleated protective clothing according to the exemplary embodiment of the present invention.

FIG. 12 is a diagram illustrating the case where a pocket of the circulation part is opened in the pleated protective clothing according to the exemplary embodiment of the present invention.

FIG. 13 is a diagram illustrating the case where the circulation part is primarily opened/closed in the pleated protective clothing according to the exemplary embodiment of the present invention.

FIG. 14 is a diagram illustrating the case where a contamination identifying part is mounted in the pleated protective clothing according to the exemplary embodiment of the present invention.

FIG. 15 is a diagram illustrating the case where the detachable contamination identifying part is spaced apart from the protective clothing in the pleated protective clothing according to the exemplary embodiment of the present invention.

### MODE FOR CARRYING OUT THE INVENTION

The advantages and characteristics of the present invention, and a method for achieving the advantages and characteristics will become clear by referring to the exemplary embodiment, which is described in detail, together with the accompanying drawings.

However, the present disclosure is not limited to exemplary embodiments disclosed herein but will be implemented in various forms.

The exemplary embodiments are provided so that the present disclosure is completely disclosed, and a person of ordinary skilled in the art can fully understand the scope of the present invention.

Further, the present disclosure will be defined only by the scope of the appended claims.

Thus, in some exemplary embodiments, well-known components, well-known operations, and well-known techniques have not been described in detail in order to avoid obscuring the present invention.

Throughout the specification, the same reference numeral indicates the same constituent element, and a term used in the present specification is for describing the exemplary embodiments, and does not intend to limit the present invention.

In the present specification, a singular form includes a plural form as well, unless otherwise mentioned, and a term “comprises” and/or “comprising” do not exclude the existence or an addition of one or more other constituent elements, in addition to the mentioned constituent element.

Unless otherwise defined, all of the terms (including technical and scientific terms) used in the present specification may be used as a meaning commonly understandable by those skilled in the art.

Further, terms defined in a generally used dictionary shall not be construed as being ideal or excessive in meaning unless they are clearly defined.

Hereinafter, an exemplary embodiment of the present invention will be described with reference to the accompanying drawings.

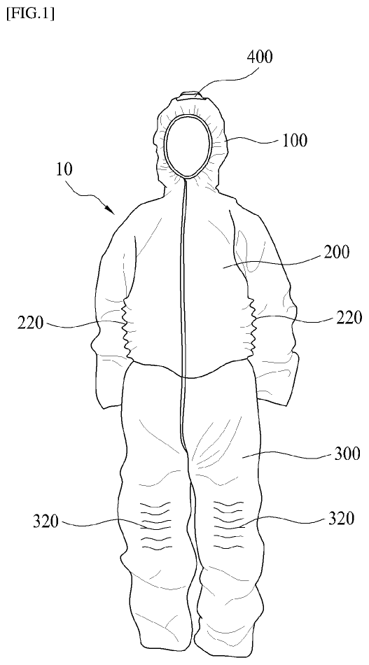

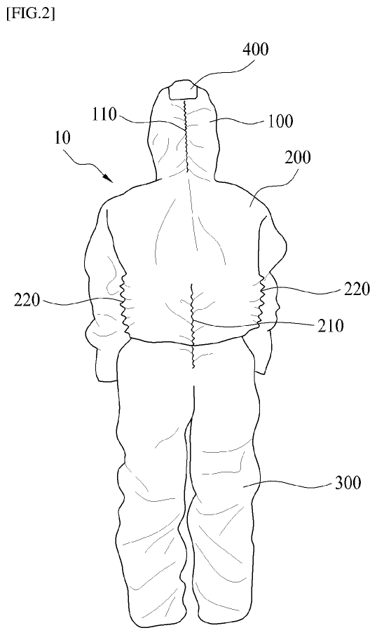

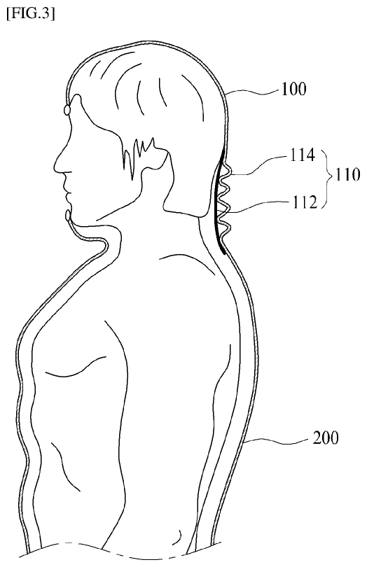

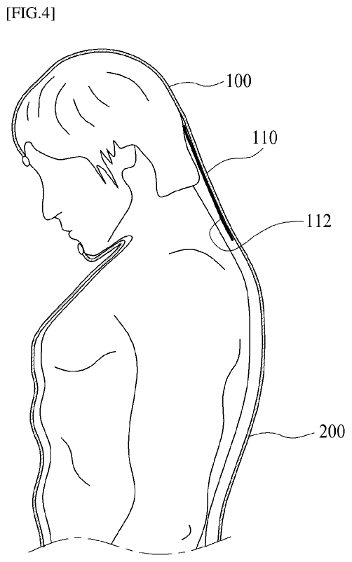

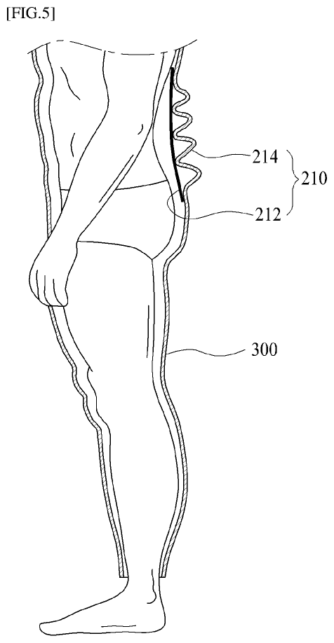

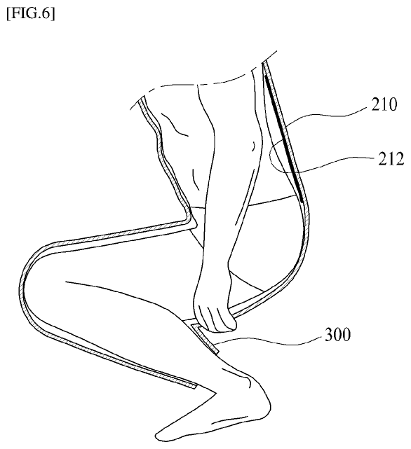

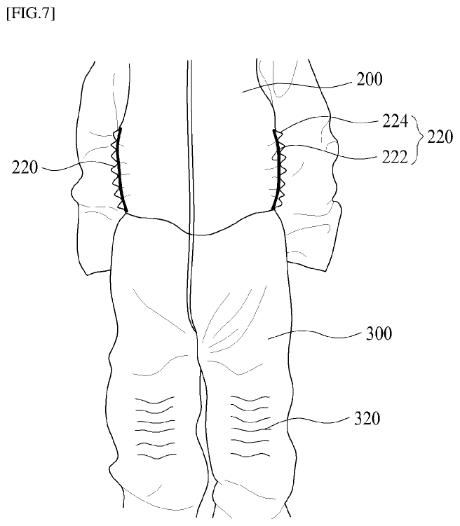

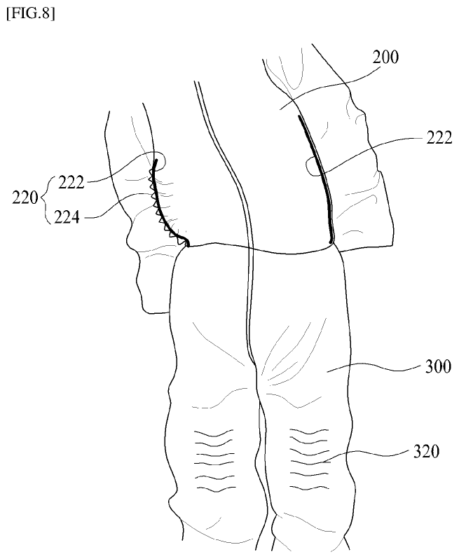

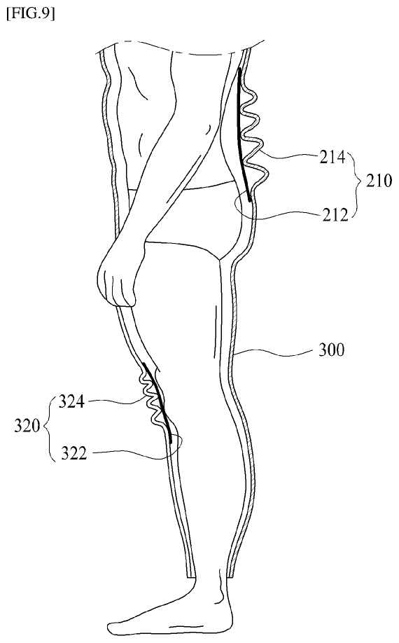

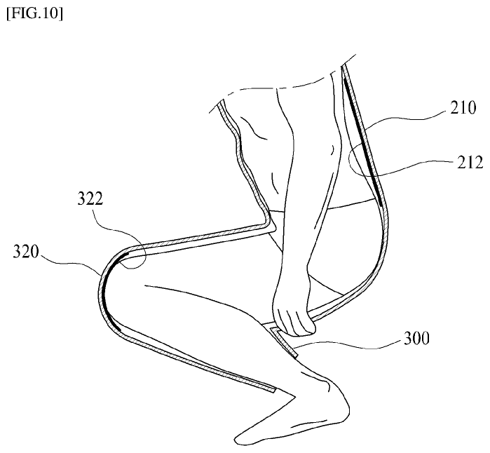

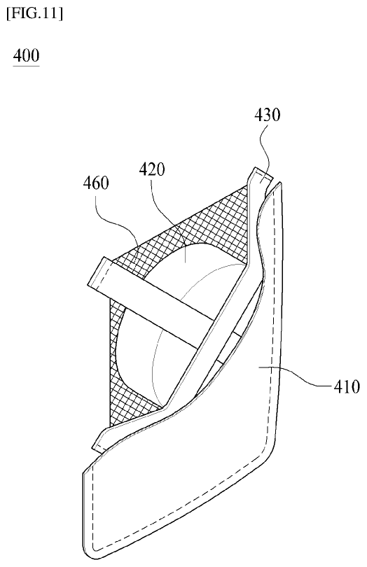

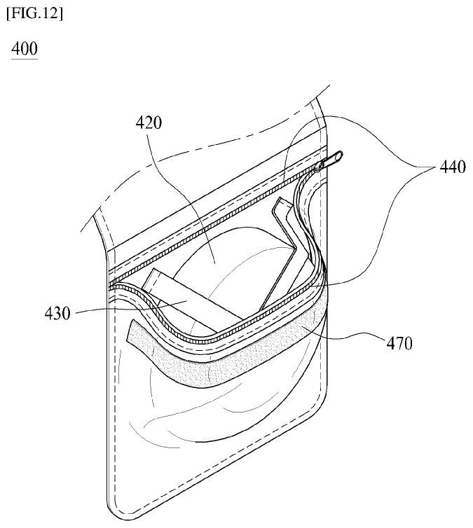

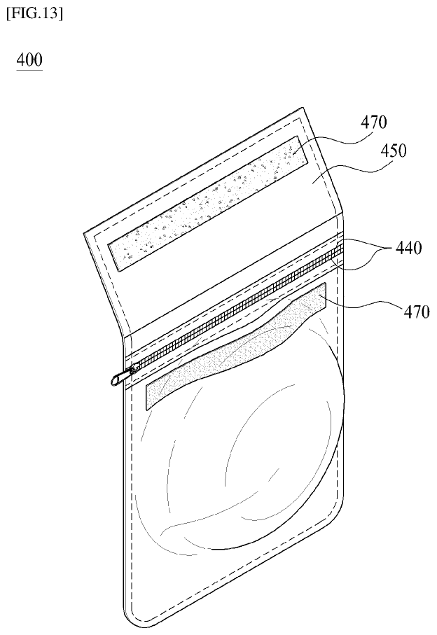

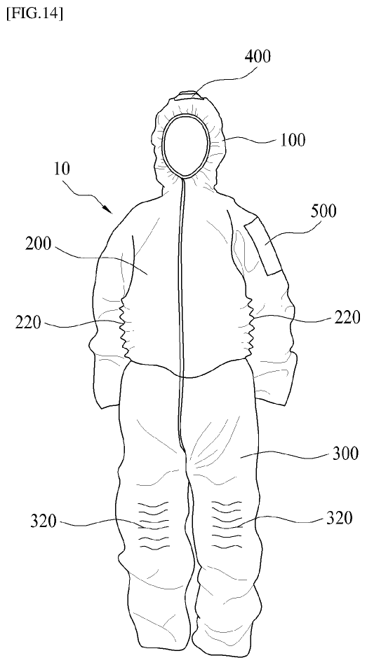

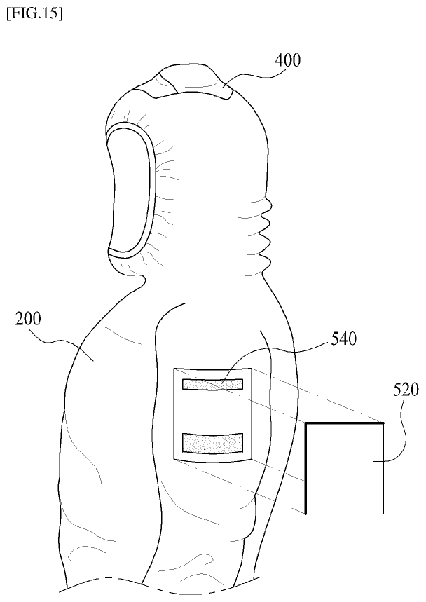

FIG. 1 is a diagram illustrating a shape of a front part of pleated protective clothing 10 according to an exemplary embodiment of the present invention, FIG. 2 is a diagram illustrating a shape of a rear part of the pleated protective clothing 10 according to the exemplary embodiment of the present invention, FIG. 3 is a cross-sectional view in the state where a neck pleated portion is bent in the pleated protective clothing 10 according to the exemplary embodiment of the present invention, FIG. 4 is a cross-sectional view in the state where the neck pleated portion is stretched in the pleated protective clothing 10 according to the exemplary embodiment of the present invention, FIG. 5 is a cross-sectional view in the state where a waist pleated portion 210 is bent in the pleated protective clothing 10 according to the exemplary embodiment of the present invention, FIG. 6 is a cross-sectional view in the state where the waist pleated portion 210 is stretched in the pleated protective clothing 10 according to the exemplary embodiment of the present invention, FIG. 7 is a cross-sectional view in the state where a lateral pleated portion 220 and a knee pleated portion 320 are bent in the pleated protective clothing 10 according to the exemplary embodiment of the present invention, FIG. 8 is a cross-sectional view in the state where the lateral pleated portion 220 is bent and stretched in the pleated protective clothing 10 according to the exemplary embodiment of the present invention, FIG. 9 is a cross-sectional view in the state where the knee pleated portion 320 is bent in the pleated protective clothing 10 according to the exemplary embodiment of the present invention, FIG. 10 is a cross-sectional view in the state where the knee pleated portion 320 is stretched in the pleated protective clothing 10 according to the exemplary embodiment of the present invention, FIG. 11 is a perspective view illustrating a circulation part 400 in the pleated protective clothing 10 according to the exemplary embodiment of the present invention, FIG. 12 is a diagram illustrating the case where a pocket of the circulation part 400 is opened in the pleated protective clothing 10 according to the exemplary embodiment of the present invention, FIG. 13 is a diagram illustrating the case where the circulation part 400 is primarily opened/closed in the pleated protective clothing 10 according to the exemplary embodiment of the present invention, FIG. 14 is a diagram illustrating the case where a contamination identifying part 500 is mounted in the pleated protective clothing 10 according to the exemplary embodiment of the present invention, and FIG. 15 is a diagram illustrating the case where the detachable contamination identifying part 500 is spaced apart from the protective clothing 10 in the pleated protective clothing 10 according to the exemplary embodiment of the present invention.

As illustrated in FIGS. 1 and 2, the protective clothing 10 according to the present invention is provided to be wearable for protecting a worker from contamination, and generally includes a hood portion 100, an upper body portion 200, and a lower body portion 300.

First, the hood portion 100, the upper body portion 200, and the lower body portion 300 may be divided such that the hood portion 100 is a portion covering a head of a worker, and the upper body portion 200 surrounds the upper body, and the lower body portion 300 surrounds the lower body.

A back neck portion that connects the hood portion 100 and the upper body portion 200 may include a hood pleated portion having elasticity.

The hood pleated portion may include a neck vertical string 112 and a neck pleat bending portion 114.

As illustrated in FIGS. 3 and 4, the hood pleated portion is formed long from the back of the head of the worker toward the neck, and the neck pleat bending portion 114 is formed of a plurality of pleats, and the neck vertical string 112 is formed longer than the neck pleat bending portion 114 inside the protective clothing 10.

In the present exemplary embodiment, the neck vertical string 112 may be provided in a length of 10 to 20 cm.

The neck vertical string 112 is elongated in the state in which the neck pleat bending portion 114 is straightened, and the neck vertical string 112 is contracted when the neck pleat bending portion 114 is formed with pleat, and the neck vertical string 112 may maintain the pleat shape of the neck pleat bending portion 114 and help the worker to raise his/her head.

Then, when the worker bows his head, the neck pleat bending portion 114 is straightened and the neck vertical string 112 is elongated, thereby preventing the upper body portion 200 from being pulled upward due to a user action and preventing the protective clothing 10 from sagging when the worker raises the head.

It is preferable that the neck pleat bending portion 114 is formed with a number of pleats so as to be straight as much as possible when the worker bows the head.

A waist pleat portion 210 may be formed at a waist portion in the same form as that of the hood pleat portion.

Next, as illustrated in FIGS. 5 and 6, the waist pleat portion 210 may include a waist vertical string 212 and a waist pleat bending portion 214 vertically formed in the protective clothing 10 along the spine.

The waist pleat bending portion 214 is provided in the form having the plurality of pleats, and the waist vertical string 212 made of an elastic material may be formed inside the protective clothing 10.

In the present exemplary embodiment, the waist vertical string 212 may be provided in a length of 10 to 20 cm.

The waist vertical string 212 is provided to be elongated in the state where the waist pleated bending portion 214 is straightened and is contracted when the waist pleated bending portion 214 is pleated, and maintains the pleated shape of the waist pleated bending portion 214 and helps the worker to rapidly raise the waist.

Further, when the workers bends the waist, the waist pleated bending portion 214 is straightened and the waist vertical string 212 is elongated, thereby preventing the lower body portion 300 from being pulled upward due to the user's action and the protective clothing 10 from sagging when the worker stretches the waist.

It is preferable that a number of pleats are formed so that the waist pleated bending portion 214 is straightened as much as possible when the worker bends the waist.

In the meantime, the lateral pleated portion 220 may be formed on the lateral surface of the protective clothing 10.

The lateral pleated portion 220 is formed between the armpit and the pelvis of the worker in the vertical direction, and may include at least one lateral vertical string 222 and a lateral pleated bending portion 224 in which a plurality of pleats is vertically formed by the lateral vertical string 222.

Further, in the protective clothing 10, the knee pleated portion 320 may be formed in a portion corresponding to the knee of the worker.

The knee pleated portion 320 is formed between the thigh and the shin, and may include at least one knee vertical string 322 and a knee pleated bending portion 324 in which a plurality of pleats is vertically formed by the knee vertical string 322.

The lateral pleated portion 220 and the knee pleated portion 320 are illustrated in FIGS. 7 to 10, and have the same functions as those of the neck pleated portion 320 and the waist pleated portion 210, so that the detailed descriptions thereof will be omitted.

Next, the circulation part 400 will be described with reference to FIGS. 11 to 13.

The circulation part 400 is provided in at least one of the hood portion 100, the upper body portion 200, and the lower body portion 300, and lowers a body temperature of the worker by injecting air into the protective clothing 10.

In the present exemplary embodiment, the circulation part 400 is formed in the hood portion 100, but depending on the exemplary embodiment, the circulation part 400 may be formed on a rear surface of the lower body portion 300 and a portion corresponding to the hip of the worker, and may also be formed in each of the hood portion 100, the upper body portion 200, and the lower body portion 300, and thus the scope of the present invention is not limited by the limited location and the limited number of circulation parts 400 formed in the protective clothing 10.

The circulation part 400 may include a pocket 410 formed in the protective clothing 10, a blower fan 420 inserted into the pocket 410, a fixing band 430 for fixing the blower fan inside the pocket 410, and an opening/closing part and a cover for opening and closing the pocket 410.

First, the pocket 410 may be formed by cutting off a portion of the protective clothing 10 or may be formed by padding a fabric.

In the present exemplary embodiment, a part adjacent to the skin may be formed with a mesh-shaped ventilation net 460 to facilitate air transfer into the protective clothing 10.

The blower fan 420 may be fixed to the position corresponding to the ventilation net 460.

The fixing band 430 fixing the blower fan 420 may have at least two elastic bands inside the pocket 410 formed in an “X” shape, and through the fixing band 430, it is possible to prevent the blower fan 420 from operating or shaking after the blower fan 420 is accommodated and it is possible to easily take out the blower fan 420 from the pocket 410 or fix the blower fan 420.

Further, the pocket 410 is provided to be able to be opened and closed, and is formed to be double-locked to prevent external contaminants from flowing into the pocket 410.

In particular, an opening/closing part in the form of a zipper is formed in the opened upper portion so that the blower fan 420 is inserted, and a cover for secondarily close the opened upper portion may be formed.

In the meantime, the protective clothing 10 may include the contamination identifying part 500 that is capable of checking whether the protective clothing 10 is contaminated.

The contamination identifying part 500 may be provided in the form of a pad 520 to be detachably attached to a part of the protective clothing 10.

Therefore, in the present exemplary embodiment, the contamination identifying part 500 is provided in the form of Velcro, and may be made of a material bendable together with the protective clothing 10.

Referring to FIGS. 14 and 15, the contamination identifying part 500 is formed in the arm of the protective clothing 10, and is provided with the pad 520 and an adhesive member 540.

One surface of the pad 520 may be provided with a material capable of confirming the degree of contamination, and the other surface thereof may be formed to be attached to the adhesive member 540.

The pad 520 contains a component changed due to contamination, such as viruses or chemicals, and through this, the color of the pad 520 is changed according to the time of exposure to the contamination.

For example, the pad 520 may be changed to white when exposed to the contamination for 0 to 1 hour, grey when exposed to the contamination for 1 to 3 hours, and black when exposed to the contamination for 3 to 5 hours.

As described above, the optimum exemplary embodiment has been disclosed in the drawings and the specification. Herein, the specific terms used herein are for purposes of illustration, but are only used for the purpose of describing the present invention, and are not used to limit the meaning or the scope of the present invention described in the claims. Accordingly, those skilled in the art will appreciate that various modifications and equivalent embodiments may be made without departing from the scope and spirit of the present invention. Therefore, the true technical protection scope of the present invention will be defined by the technical spirit of the accompanying claims.

1. A pleated protective clothing worn by a worker in order to protect a body of a worker from an external environment and maintain a clean work environment, the pleated protective clothing comprising:
a hood portion configured to cover a head of a worker;
an upper body portion connected with the hood portion and configured to surround an upper body of the worker; and
a hood pleated portion formed in a portion connecting the hood portion and the upper body portion and having elasticity.

2. The pleated protective clothing of claim 1, wherein the hood pleated portion is formed of at least one neck vertical string, and a neck pleated bending portion in which a plurality of pleats is vertically formed by the neck vertical string.

3. The pleated protective clothing of claim 1, further comprising:
a lower body portion connected with the upper body portion and configured to surround a lower body of the worker; and
a waist pleated portion formed in a portion connecting the upper body portion and the lower body portion and having elasticity.

4. The pleated protective clothing of claim 3, wherein the waist pleated portion is formed of at least one waist vertical string, and a waist pleated bending portion in which a plurality of pleats is vertically formed by the waist vertical string.

5. The pleated protective clothing of claim 3, further comprising:
a lateral pleated portion formed in the portion connecting the upper body portion and the lower body portion and having elasticity.

6. The pleated protective clothing of claim 5, wherein the lateral pleated portion is formed of at least one lateral vertical string, and a lateral pleated bending portion in which a plurality of pleats is vertically formed by the lateral vertical string.

7. The pleated protective clothing of claim 3, wherein the lower body portion includes a knee pleated portion which is formed at a position corresponding to a knee and has elasticity.

8. The pleated protective clothing of claim 7, wherein the knee pleated portion is formed of at least one knee vertical string, and a knee pleated bending portion in which a plurality of pleats is vertically formed by the knee vertical string.

9. The pleated protective clothing of claim 3, further comprising:
a circulation part provided in at least one of the hood portion, the upper body portion, and the lower body portion.

10. The pleated protective clothing of claim 9, wherein the circulation part includes:
a pocket formed in the protective clothing; and
a blower fan operated in the state of being inserted into the pocket.

11. The pleated protective clothing of claim 10, wherein
the circulation part is made of an elastic material, and includes a fixing band which is formed inside the pocket and fixes the blower fan.

12. The pleated protective clothing of claim 3, further comprising:
a contamination identifying part which is provided in at least one of the hood portion, the upper body portion, and the lower body portion, and determines the degree of contamination of the protective clothing.

13. The pleated protective clothing of claim 12, wherein the contamination identifying part is provided to be detachably attached to the protective clothing.
